(19) United States
(12) Patent Application Publication
(10) Pub. No.: US 2019/0348884 A1
(43) Pub. Date: Nov. 14, 2019

(54) Contact Ring, Stator and Electric Motor

(71) Applicant: CPT Group GmbH, Hannover (DE)

(72) Inventors: Alexandru POPA, Rimnicu Vilcea (RO); Daniel-losif BALINT, Timisoara (RO); Eusebio-Marius ALBERT, Mosnita Veche (RO)

(21) Appl. No.: 16/335,187

(22) PCT Filed: Sep. 21, 2017
(86) PCT No.: PCT/EP2017/073909

§ 371 Date: Mar. 20, 2019

(30) Foreign Application Priority Data
Sep. 22, 2016 (EP) 16465538.3

(51) Int. Cl. H02K 3/52; H02K 3/18

(52) U.S. Cl. CPC H02K 3/521; H02K 2203/09; H02K 3/18

(57) ABSTRACT

A contact ring arrangable on a stator of an electronically commutated electric motor includes at least two pairs of identical, part-annular, metallic elements. Each of the pairs is connected to a terminal lug for attaching to a voltage source. A first one of the two elements of a pair extends from the terminal lug in a first circumferential direction of the stator in a first normal position, and a second one of the two elements extends from the terminal lug in a second circumferential direction of the stator in a second position turned with respect to the first normal position. The identical, part-annular, metallic elements each have an offset 8, configured such that two elements of the contact ring that face one another of two adjacent terminal lugs overlap in the region of the offset without coming into contact.

### CROSS REFERENCE TO RELATED APPLICATIONS

This is a U.S. national stage of application No. PCT/EP2017/073909, filed on Sep. 21, 2017, which claims priority to European Application No. 16465538.3, filed Sep. 22, 2016, the content of each of which is incorporated herein by reference.

### BACKGROUND OF THE INVENTION

### 1. Field of the Invention

The invention relates to a contact ring for arranging on a stator of an electronically commutated electric motor, to a stator having a contact ring of this type, and to an electric motor having a stator of this type.

### 2. Description of the Prior Art

A contact ring of the above-referenced type, which can be configured in multiple pieces according to the prior art, forms a busbar that connects individual terminal lugs or elements for attaching to a voltage source with a stator winding. Here, the terminal lugs can be configured in one piece with the contact ring or the individual contact ring elements.

### SUMMARY OF THE INVENTION

It is an object of the present invention to provide a contact ring that makes simpler production and assembly possible in comparison with the contact rings known according to the prior art.

According to one aspect of the invention, a contact ring for arranging on a stator of an electronically commutated electric motor is provided, the contact ring being configured from at least two pairs of identical, part-annular, metallic elements. In each case one of the pairs is connected to a terminal lug or a terminal element for attaching to a voltage source.

In this aspect, one of the two elements of a pair extends from the terminal lug in a first circumferential direction of the stator in a first normal position, and the other element extends from the terminal lug in a second circumferential direction of the stator in a second position that is turned with respect to the first normal position.

In this aspect, the individual elements have an offset, arranged such that two elements of the contact ring that face one another of two adjacent terminal lugs overlap or cross in the region of the offset without coming into contact.

In the context of this invention, the abovementioned normal position is to be understood to mean that the corresponding element is arranged such that the correspondingly facing element of the adjacent terminal lug can be arranged in a position that is turned with respect to it, without the two elements coming into contact.

The proposed contact ring affords a plurality of advantages. Firstly, in one aspect, the contact ring is assembled from identical elements, with the result that a distinction does not have to be made between the elements. This simplifies both the production and the assembly of the elements.

Moreover, in one aspect, the individual elements do not have to be assembled at the same time. This also simplifies the assembly of the elements. Rather, the individual elements can be arranged one after another, by first arranging an element in a normal position and then arranging the correspondingly associated element of the adjacent terminal lug in the position turned with respect thereto. As an alternative, in principle first the elements to be arranged in the normal position can also be arranged and subsequently all the elements that are turned with respect thereto or the correspondingly associated elements of the adjacent terminal lugs in the position that is turned with respect thereto can be arranged.

It is a further advantage that the individual elements do not have to be reshaped during the arranging, in order to configure the overlaps or crossovers in the regions of the individual offsets. This also simplifies the assembly of the elements.

According to one aspect, the offsets of the elements which face one another overlap in a complementary manner in a common offset region. This simplifies the assembly and makes a very compact overall design possible, which contributes to saving installation space.

According to a further aspect, the contact ring is configured from at least three pairs of identical, part-annular, metallic elements. A configuration of the contact ring with, for example, three pairs of elements of this type is suitable for a three-strand stator winding, which ensures improved smooth running of a rotor of the electric motor in comparison with a merely two-strand stator winding, for which a configuration of the contact ring with two pairs of elements of this type is suitable.

The individual elements of the contact ring can expediently be configured as flat elements, the broad sides of which are oriented toward the end side of the stator. This makes a very compact overall design possible.

The offset of the individual elements can be configured between a terminal lug end and a free end of the element. Here, the offset can be oriented in the longitudinal direction of the stator. This also makes a very compact overall design possible.

According to one aspect, the individual elements are divided into individual sections and in the process have:
a first radial section for attaching to the terminal lug,
a first circumferential section that adjoins the first radial section,
an offset section that adjoins the first circumferential section and has the offset,
a second radial section that adjoins the offset section, and
a second circumferential section which adjoins the second radial section for attaching to the stator winding.

According to one aspect, the individual sections lie in one plane apart from the offset of the offset section. This makes a very compact overall design possible and contributes to saving installation space. Here, the offset section can be deep-drawn with respect to the remaining sections.

Since these are, in one aspect, identical elements, the offsets of the respective normally arranged elements also lie in one plane and the offsets of the respective elements, which are arranged in a turned manner with respect thereto, lie in another plane. This also contributes to the compact overall design.

Furthermore, one of the two circumferential sections of the element can be arranged so as to lie on the inside with respect to the other circumferential section. According to one aspect, the first circumferential section is arranged so as to lie on the inside with respect to the second circumferential section. This also contributes to the compact overall design.

The second circumferential section can be provided with two connector faces, preferably with two circular connector faces for attaching to the stator winding.

Each individual element of the contact ring can extend over an angular range of from approximately 100° to 120°, preferably over substantially 115°. In relation to the abovementioned configuration of the contact ring with the three pairs of elements of this type, the three pairs are arranged offset with respect to one another by substantially 120°.

Furthermore, each of the elements can advantageously be configured as a stamped sheet metal element. Stamped sheet metal elements of this type can be produced inexpensively. As an alternative, the elements can also be cut from a flat metal sheet by a laser.

According to one embodiment, the two elements that face one another of the contact ring of two adjacent terminal lugs are insulated electrically with respect to one another, by an insulator being provided in the region of the first circumferential section on the side that faces the stator, against which insulator a winding wire of the stator winding bears. The insulator suppresses a short circuit between the two current-conducting elements.

Here, the insulator can be made of plastic, preferably in the shape of a U-profile, which can be molded on the stator on the end side or can be clipped into the stator.

In addition or as an alternative thereto, it is even possible for the respective element to be insulated itself at least in the region of the first circumferential section by being injection-molded accordingly.

Furthermore, a stator of an electronically commutated electric motor having a contact ring of the above-described type is proposed.

In addition, an electric motor having a stator of the above-described type is proposed.

### BRIEF DESCRIPTION OF THE DRAWINGS

In the further text, the invention will be explained in detail with reference to the illustrations of the figures. Further advantageous developments of the invention arise from the following description of preferred embodiments. In the drawings:

FIG. 1 shows a perspective illustration of a proposed contact ring;

FIG. 2 shows an arrangement of the contact ring shown in FIG. 1 on a stator;

FIG. 3 shows an enlarged detail of the arrangement shown in FIG. 2;

FIGS. 4A-4C show three views of a contact ring element;

FIGS. 5A and 5B show two views of two elements of the contact ring that face one another of two adjacent terminal lugs;

FIG. 6 shows the contact ring shown in FIG. 1, in a view from below;

FIGS. 7A and 7B show the contact ring shown in FIG. 6, in a front view and a magnified view of an area of detail of the contact ring;

FIGS. 8A-8C show a contact ring with convex connector faces and sectional views thereof;

FIGS. 9A and 9B show a perspective illustration of the contact ring shown in FIG. 8A and a sectional view thereof;

FIG. 10A shows an arrangement of a further contact ring on a stator; and

FIG. 10B shows a sectional illustration of the arrangement shown in FIG. 10A.

### DETAILED DESCRIPTION OF THE PRESENTLY PREFERRED EMBODIMENTS

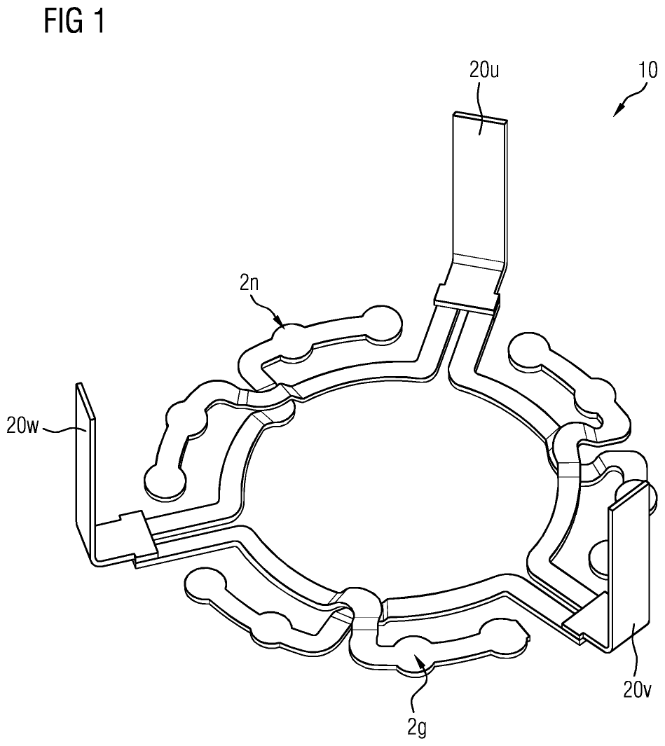

FIG. 1 shows a contact ring 10 which, per se, represents a current-conducting body connectable via the terminal lugs 20U, 20V, 20W, to a voltage source (not shown here).

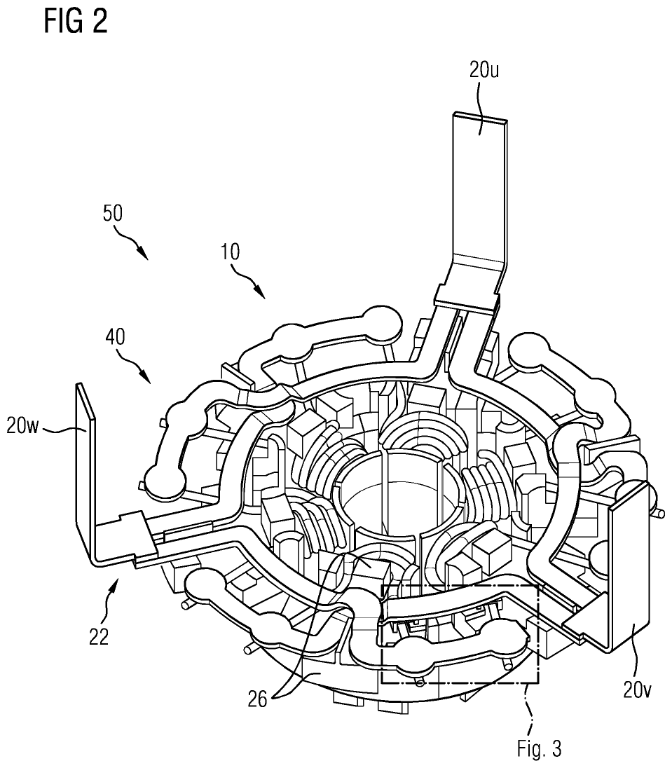

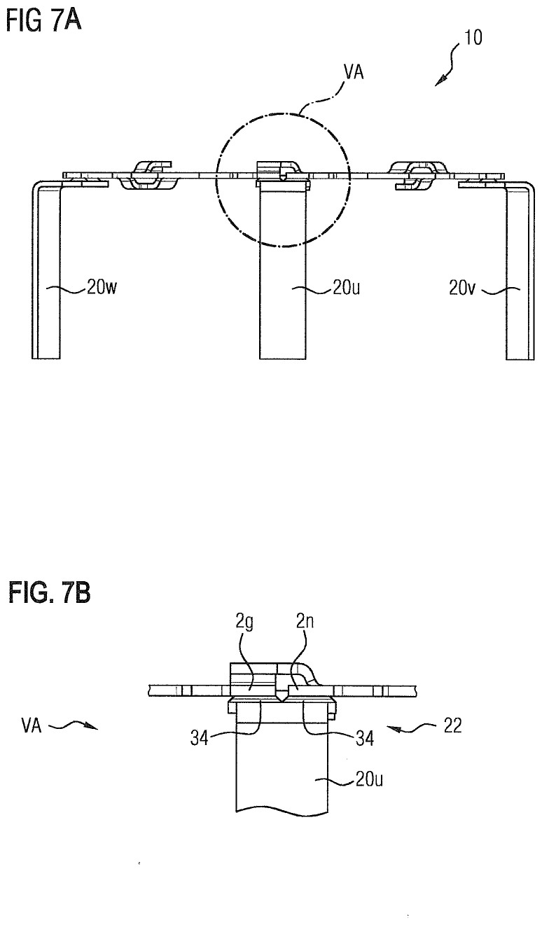

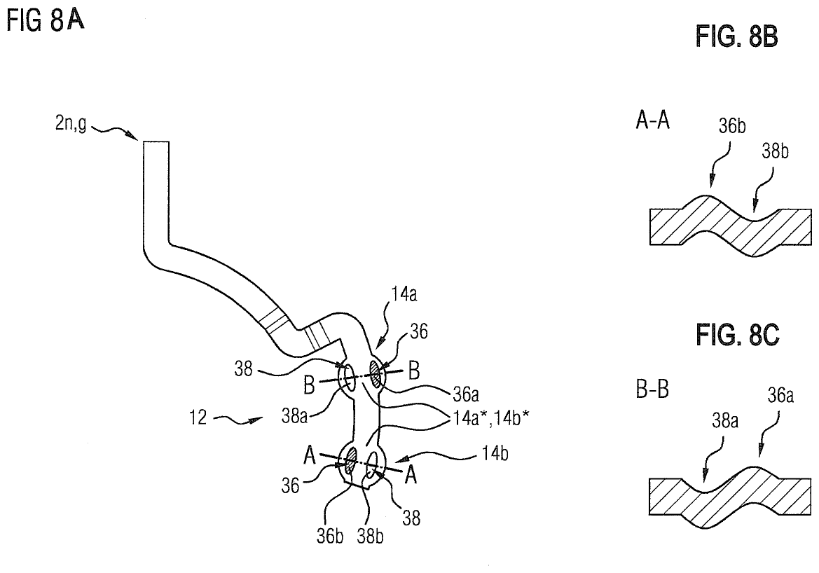

The contact ring 10 is assembled from a total of six identical, flat, part annular, metallic elements 2n, 2g or three pairs of identical, flat, part-annular, metallic elements 2n, 2g. A pair of this type is to be understood to mean in each case the two elements which are assigned to one of the three flat, metallic and L-shaped terminal lugs 20U, 20V, 20W which are shown in FIG. 1. The individual elements 2n, 2g are configured, for example, as stamped sheet metal elements and are spot welded to the associated terminal lugs 20U, 20V, 20W at the connecting point 22 (see FIG. 2). FIG. 7B shows the welded points 34 at the connecting point 22 in an enlarged view VA. The terminal lugs 20U, 20V, 20W are arranged offset with respect to one another by 120°, with the result that the respective pairs are also arranged offset with respect to one another by 120° (cf. FIG. 6).

Furthermore, FIG. 1 shows how the individual elements 2n, 2g are arranged with respect to one another. Whereas one of the two elements 2n of a respective pair assigned to a respective terminal lug 20U, 20V, 20W extends in a first circumferential direction in a first normal position, the other element 2g of the respective pair extends from its associated respective terminal lug 20U, 20V, 20W in a second circumferential direction in a second position that is turned with respect to the first normal position.

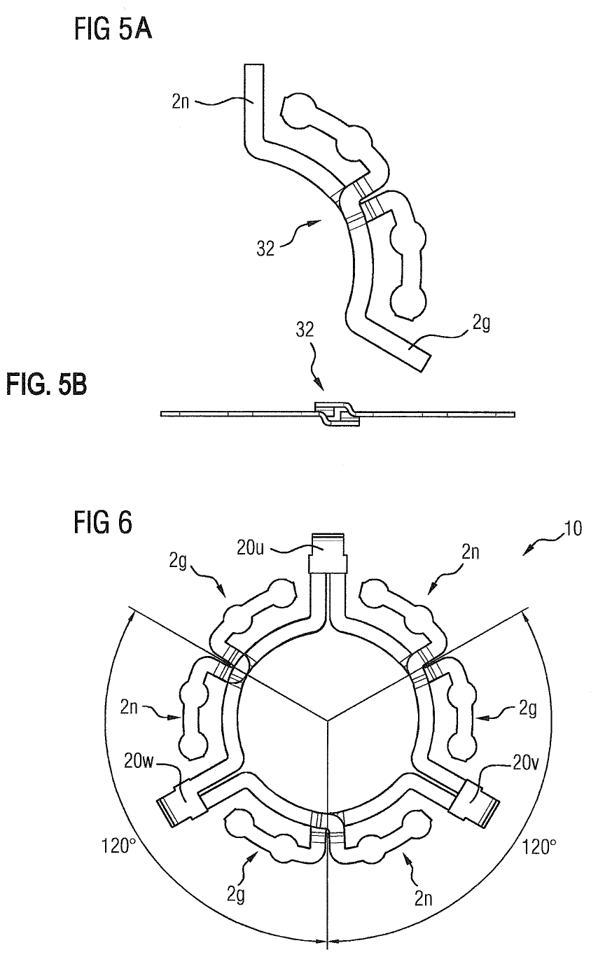

As a result, two elements 2n, 2g that face one another of two adjacent terminal lugs 20U, 20V, 20W overlap in the region of an offset 8 without coming into contact. Here, the offsets 8 overlap in a complementary manner in a common offset region 32 (cf. FIG. 1, FIGS. 5A and 5B). The offset regions 32 are also arranged offset with respect to one another by 120° (see FIG. 6).

The individual offsets 8 are configured between a terminal lug end 3 and a free end 18 of the element 2n, 2g. In an installed position of the contact ring 10, said offsets are oriented in the longitudinal direction of a stator 40 (cf. FIG. 2).

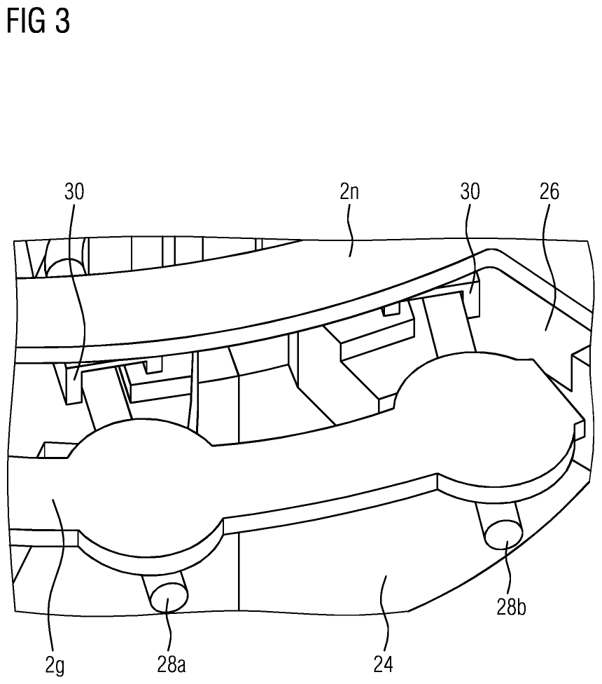

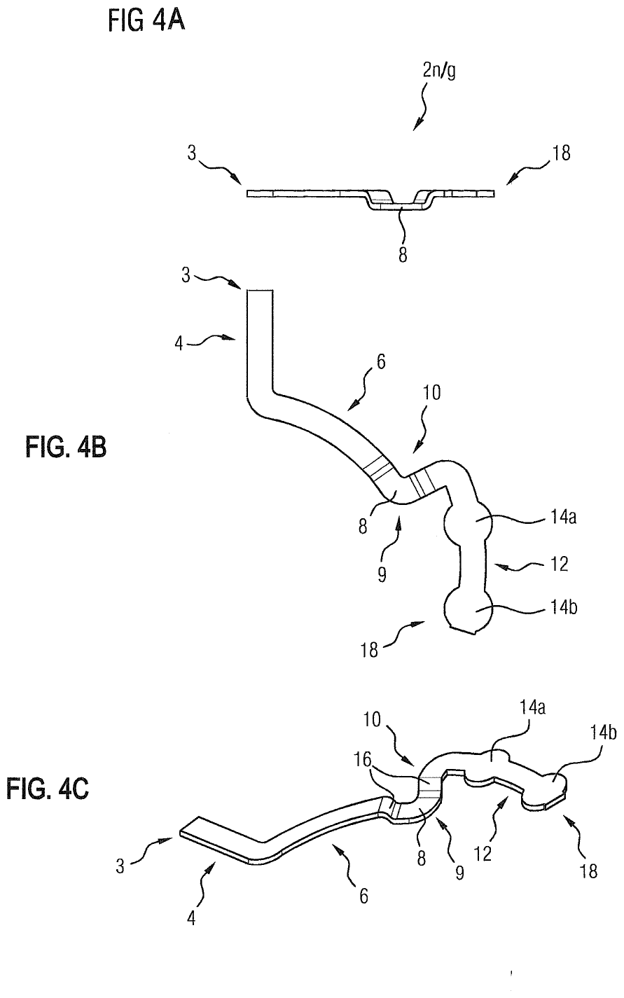

Each individual element 2n, 2g is divided into a plurality of sections and in the process has, in detail (cf. FIGS. 4A, 4B and 4C):
a first radial section 4 for attaching to one of the terminal lugs 20U, 20V, 20W,
a first circumferential section 6 which adjoins the first radial section 4,
an offset section 9 which adjoins the first circumferential section 6 and has the offset 8,
a second radial section 10 which adjoins the offset section 9, and
a second circumferential section 12 which adjoins the second radial section 10 for attaching to two coil windings 28a, 28b (see FIG. 3).

In relation to the contact ring 10, the two radial sections 4, 10 cause the first circumferential section 6 to be arranged so as to lie on the inside with respect to the second circumferential section 12.

The individual sections 4, 6, 10, 12 lie in one plane apart from the offset section 9 (see FIGS. 5, 7A and 7 B. The offset section 9 is deep-drawn with respect to the remaining sections 4, 6, 10, 12 and therefore forms the offset 8 which is oriented in the longitudinal direction of the stator 40 in the installation position of the contact ring 10 (see FIG. 2). The offset section 9 comprises a bend 16 in the transition region to the first circumferential section 6 on one side and a bend 16 in the transition region to the second radial section 10 on the other side.

The second circumferential section 12 is provided with two substantially circular connector faces 14a, 14b for attaching to the two coil windings 28a, 28b.

Each individual element 2n, 2g extends over an angular range of from approximately 100° to 120°, preferably over approximately 115°.

Since these are identical elements 2n, 2g, the offsets 8 of the respective normally arranged elements 2n also lie in one plane and the offsets 8 of the respective elements 2g which are arranged turned with respect thereto lie in another plane (cf. FIGS. 7A and 7B).

FIG. 2 shows the contact ring 10 on the stator 40 of a brushless DC motor 50. The stator 40 comprises metallic stator segments 24 (see FIG. 3), which carry in each case one coil winding. Overall, the individual coil windings form the stator winding. In this exemplary embodiment, the stator winding comprises a total of three winding strands or six coil windings which are energized via an electronic bridge circuit.

The individual elements 2n, 2g (see FIG. 3) are oriented with one of their two broad sides toward the end side of the stator 40. The contact ring 10 is arranged on the stator 40 on the end side such that it firstly lies on a plastic encapsulation 26 of the stator 40 by the respective first circumferential sections 6 (see FIGS. 4B and 4C), by way of which plastic encapsulation 26 the contact ring 10 is positioned and fixed. Secondly, the contact ring 10 lies by the respective circular connector faces 14a, 14b of the respective second circumferential sections 12 on in each case two winding wires 28a, 28b. Whereas one of the winding wires 28a provides the start of one coil winding, the other winding wire 28b provides the end of another coil winding.

FIG. 3 shows that two elements 2n, 2g that face one another of two adjacent terminal lugs 20V, 20W are insulated electrically with respect to one another, in order to suppress a short circuit between the two current-conducting elements 2n, 2g. This is ensured by virtue of the fact that two insulators 30 are provided in the respective region of the first circumferential section 6 on the side that faces the stator 40, against which insulators 30 the two winding wires 28a, 28b bear.

Here, the insulators 30 are made of plastic in the shape of a U-profile, which can be molded on the stator 26 on the end side. As an alternative, the insulators 30 can also be clipped into the plastic encapsulation 26. As an alternative to this, the insulators 30 can also be molded on the respective element 2n, 2g itself. According to a further alternative refinement, the respective element 2n, 2g can also be insulated itself at least in the region of the first circumferential section, by being encapsulated correspondingly.

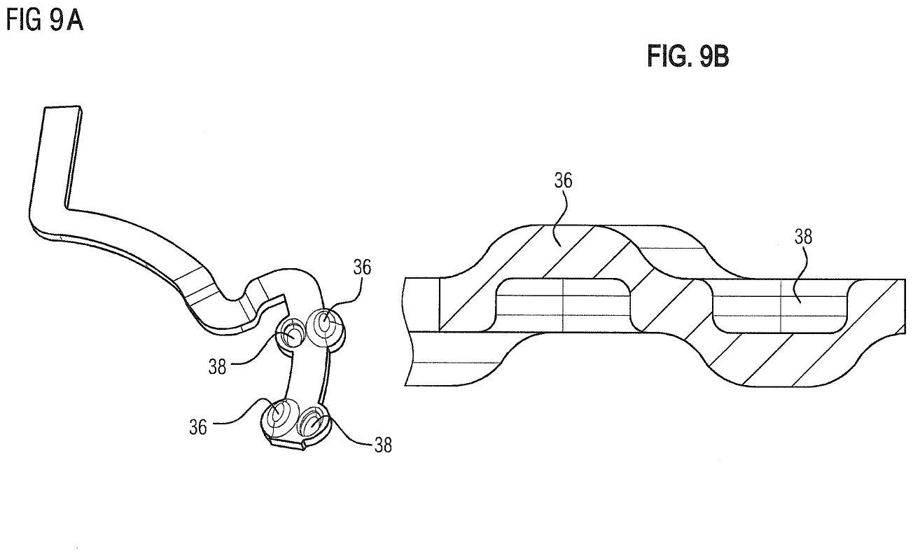

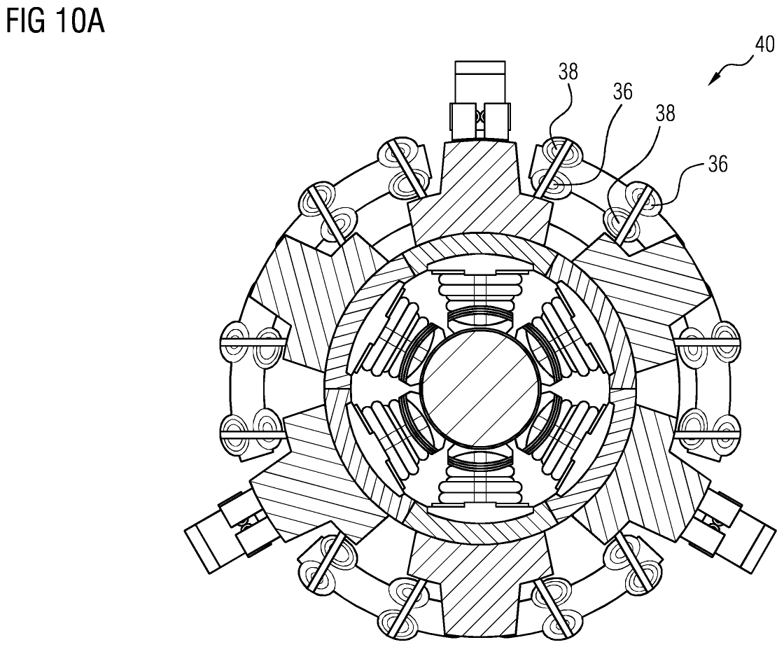

FIGS. 8A-8C and FIGS. 9A and 9B illustrate an alternative contact ring element 2n, 2g with substantially circular connector regions 14a*, 14b*, the connector faces 14a, 14b of which are provided with welding bumps 36, 38. The connector regions can in principle also have a different shape which differs from the abovementioned substantially circular shape, for instance a rectangular or polygonal shape.

Depending on the view of the contact ring element 2n, 2g, each of the connector faces 14a, 14b comprises an elevation 36 and a depression 38. A welding bump, which represents an elevation 36 of the connector face 14a, 14b in relation to the normal position 2n, represents a depression 38 of the connector face 14a, 14b in relation to the position 2g which is turned with respect to the normal position 2n, and vice versa.

If, furthermore, the two connector faces 14a, 14b are compared with one another, the elevations 36a, 36b and the depressions 38a, 38b are configured offset with respect to one another in the radial direction. This is illustrated in detail by the two sectional illustrations A-A and B-B, shown in FIGS. 8B and 8C, respectively.

In principle, according to a further alternative contact ring element, only a single welding bump can also be provided in relation to the two connector faces, that is to say, one elevation or one depression depending on the view.

Welding bumps or elevations or depressions of this type serve the purpose of aiding a welding operation.

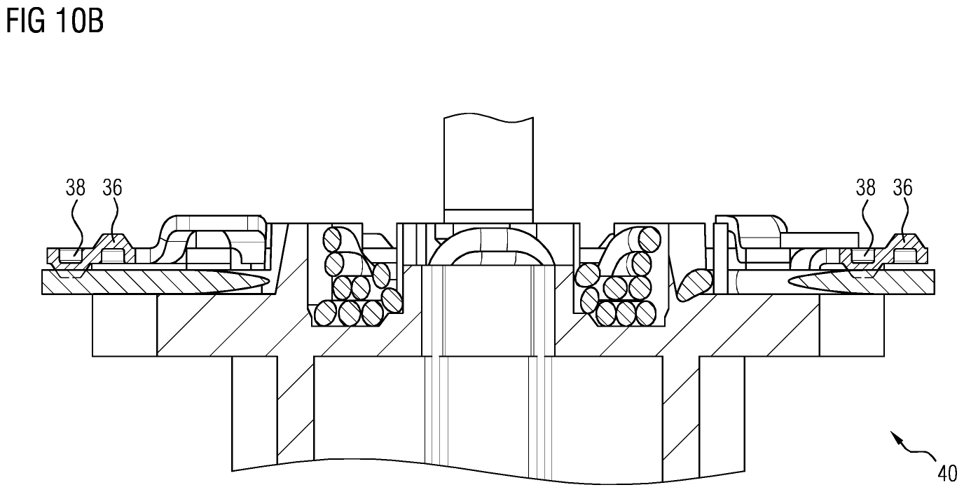

FIG. 10A and FIG. 10B illustrate a further stator 40 with a contact ring which is assembled from contact ring elements of the above-described type. Here, with regard to the connector regions 14a*, 14b*, the contact ring has in each case two welding bumps per connector face 14a, 14b. It can be seen that the individual contact points or welding points between the wires and the contact ring elements are dependent on the position of the respective contact ring element. It can also be seen that always only one of the two welding bumps per connector face 14a, 14b forms the contact point or welding point with the respectively associated wire.

The method of operation of a brushless DC motor of this type or electronically commutated electric motor will not be described in greater detail in the following text. This is known to a person skilled in the art.

Although the preceding description has described exemplary embodiments, it is to be noted that a multiplicity of variations are possible. Moreover, it is to be noted that the exemplary embodiments are merely examples which are not intended to restrict the scope protection, the applications and the construction in any way. Rather, a person skilled in the art is given a guideline for the implementation of at least one exemplary embodiment by the preceding description, it being possible for various modifications to be performed, in particular with regard to the function and arrangement of the described constituent parts, without departing from the scope of protection as arises from the claims and the equivalent combinations of features.

1-18. (canceled)

19. A contact ring arrangable on a stator (40) of an electronically commutated electric motor, the contact ring (10) comprising:
at least two pairs of identical, part-annular, metallic elements (2n, 2g),
one of the at least two pairs being attachable to a voltage source by connection to one of a plurality of terminal lugs (20U, 20V, 20W), and
a first one of the two elements (2n) of at least one of the at least two pairs (2n, 2g) extending from a respective terminal lug (20U, 20V, 20W) in a first circumferential direction of the stator (40) in a first normal position, and a second one of the two elements (2g) of the at least one of the at least two pairs (2n, 2g) extending from a second respective terminal lug (20U, 20V, 20W) in a second circumferential direction of the stator (40), in a second position turned with respect to the first normal position,
wherein each of the two elements of at least one of the at least two pairs (2n, 2g) has an offset (8), configured such that two elements (2n, 2g) of the contact ring (10) that face one another of two adjacent terminal lugs (20U, 20V, 20W) overlap in a region of the offset without coming into contact with one another.

20. The contact ring as claimed in claim 19, wherein the offsets of the elements (2n, 2g) that face one another overlap in a complementary manner in a common offset region.

21. The contact ring as claimed in claim 20, wherein the contact ring (10) comprises at least three pairs of the identical, part-annular, metallic elements (2n, 2g).

22. The contact ring as claimed in claim 19, wherein the identical, part-annular, metallic individual elements (2n, 2g) are each configured as flat elements, a broad side of each of which is oriented toward an end side of the stator (40).

23. The contact ring as claimed in claim 19, wherein each of the identical, part-annular, metallic individual elements (2n, 2g) comprises a terminal lug end (3) and a free end (18), and the offset (8) of each of the identical, part-annular, metallic individual elements (2n, 2g) being arranged between the terminal lug end (3) and the free end (18).

24. The contact ring as claimed in claim 19, wherein each offset (8) is oriented toward a longitudinal direction of the stator (40).

25. The contact ring as claimed in claim 19, the identical, part-annular, metallic individual elements (2n, 2g) being divided into individual sections so as to have:
a first radial section (4) configured to attach to a respective one of the plurality of terminal lugs (20U, 20V, 20W),
a first circumferential section (6) adjoining the first radial section (4),
an offset section (9) adjoining the first circumferential section (6) and having the offset (8),
a second radial section (10) adjoining the offset section (9), and
a second circumferential section (12) adjoining the second radial section (10) configured to attach to a stator winding.

26. The contact ring as claimed in claim 25, wherein the individual sections (4, 6, 10, 12) all lie in a common plane apart from that of the offset (8) of the offset section.

27. The contact ring as claimed in claim 26, wherein the offset section (9) is deep-drawn with respect to other ones of the individual sections (4, 6, 10, 12).

28. The contact ring as claimed in claim 27, wherein one of the first and second circumferential sections (6, 12) is arranged so as to lie inside with respect to the other one of the first and second circumferential sections (6, 12).

29. The contact ring as claimed in claim 28, wherein the first circumferential section (6) is arranged so as to lie inside with respect to the second circumferential section (12).

30. The contact ring as claimed in claim 29, wherein the second circumferential section (12) comprises two circular connector faces (14a, 14b) configured to attach to the stator winding.

31. The contact ring as claimed in claim 19, wherein each of the identical, part-annular, metallic individual elements (2n, 2g) extends over an angular range of from approximately 100° to 120°.

32. The contact ring as claimed in claim 19, wherein each of the identical, part-annular, metallic individual elements (2n, 2g) is a stamped sheet metal element.

33. The contact ring as claimed in claim 25, wherein the two elements (2n, 2g) of the contact ring (10) that face one another of two adjacent terminal lugs (20U, 20V, 20W) are insulated electrically with respect to one another by an insulator (30) arranged in the region of the first circumferential section (6) on a side facing the stator (40), against which insulator (30) a winding wire (28a, 28b) of the stator winding bears.

34. The contact ring as claimed in claim 33, wherein the insulator (30) is made of plastic, and has U-profile shape, the insulator (30) being is molded on the stator on the end side thereof or is clipped into the stator.

35. A stator of an electronically commutated electric motor having a contact ring (10) as claimed in claim 19.

36. An electric motor having a stator (40) as claimed in claim 35.

37. The contact ring as claimed in claim 19, wherein each of the identical, part-annular, metallic individual elements (2n, 2g) extends over substantially 115°.
